(19) United States
(12) Patent Application Publication
(10) Pub. No.: US 2003/0093537 A1
(43) Pub. Date: May 15, 2003

(54) Application server domains

(76) Inventors: James Tremlett, Acton, MA (US); Stevan H. Leiden, Norwood, MA (US); Moshe Sambol, Passaic, NJ (US); Thomas Antell, Westford, MA (US); Steven Gardell, North Andover, MA (US); Fardad Farahmand, Wellesley, MA (US)

Correspondence Address: Verizon Services Group, 600 Hidden Ridge, HQE03H01, Irving, TX, 75038, US

(21) Appl. No.: 10/003,394

(22) Filed: Oct. 23, 2001

(51) Int. Cl. G06F 15/16

(52) U.S. Cl. 709/228; 709/229

(57) ABSTRACT

Disclosed herein are techniques that enhance call handling by an application server. The techniques include segmenting an application into domains having associated domain policies. Such domains can include subscriber domains, service domains, device domains, and so forth. Application of the domain policies can, for example, enable different business entities to offer services from the same application server without losing control over call handling.

### BACKGROUND OF THE INVENTION

1. Field of the Invention

The invention relates generally to application servers, and more particularly to application servers used for handling calls.

2. Description of Related Art

In the past, telephone companies carried calls over a public switched telephone network (PSTN). To make a telephone connection, the phone company typically established and maintained a path (“channel”) through the PSTN linking the telephones involved in a call.

Increasingly, calls travel over packet-based computer networks such as the Internet. Essentially, a computer breaks a call down into a series of packets that each include information about a small portion of an on-going call.

Even calls originating and/or terminating at a PSTN device often travel over a packet-based network. To illustrate call handling by a packet-based network, FIG. 1 depicts an example of a telephone call between a traditional, plain old telephone 112 and an IP telephone 102 that connects to the Internet 100 instead of a PSTN 110. As shown, a call between the telephones 102, 112 includes a bearer channel 114 carrying communication content (e.g., encoded voice data) and a signaling channel 116 carrying information identifying telephone pick-up, hang-up, and so forth.

As shown in FIG. 1, a gateway 108 acts as an intermediary between the packet-based communication of IP network 100 and the channel-based communication of the PSTN network 110. That is, the gateway 108 can create packets including information received from the PSTN network 110 and transmit information to PSTN 110 based on packets received from IP network 100.

As shown, gateway 108 can divert packets, such as packets including signaling information, to a softswitch 106. Based on this signaling information, softswitch 106 can interact with gateway 108 to control the call. For example, softswitch 106 can direct gateway 108 to route bearer information to IP telephone 102 to complete a call As softswitch 106 represents an intersection point of a large number of calls, softswitch 106 offers an excellent place to monitor and intercept calls to provide different call services.

As shown in FIG. 1, softswitch 106 communicates with an application server 104. Application server 104 can provide call services ranging from voice-mail, call-forwarding, and call waiting to video conferencing, PBX (Private Branch Exchange) capabilities, unified messaging, and 911 services. Application server 104 provides these services by monitoring and directing how softswitch 106 handles a call. For example, application server 104 can cause bearer packets to be routed to a voice-mail service if a device such as IP telephone 102 does not get picked-up after some period of time.

To enable application server programmers to monitor and manipulate a call, many softswitches 106 provide an application programming interface (API) that can, for example, generate events identifying different aspects of a call. Some APIs use a call model that represents a call with a collection of software objects. For example, FIG. 2 illustrates an example of a call model known as “JTAPI” (Java Telephone Application Programmer Interface). Application server 104 software can handle a call by accessing properties and procedures (“methods”) offered by these objects.

Briefly, model 120 includes a call object 124 that represents the information flowing between call participants. As shown, a call can feature one or more connection objects 126, 128 that indicate a current logical state (e.g., idle, in-progress, and disconnected) of the relationship between the call object 124 and addresses 130, 136 (e.g., phone numbers) involved in the call. Terminal connection objects 132, 134 describe the current physical state of the relationship between the connection and call end-points known as “terminals.” Terminal objects 138, 140 represent the actual physical terminal devices involved in a call.

### SUMMARY OF THE INVENTION

Disclosed herein are techniques that can enhance call handling by an application server. The techniques include segmenting an application into domains having associated domain policies. Such domains can include subscriber domains, service domains, device domains, and so forth. Application of the domain policies can, for example, enable different business entities to offer services from the same application server without losing control over call handling.

An embodiment comprises a method of handling a call at an application server by receiving information at the application server, including data identifying a subscriber of services offered by the application server, selecting a domain policy applying to a set of subscribers, and handling the call in accordance with the selected domain policy.

Another embodiment comprises a method of providing call services at an application server by defining a set of domains which have a domain policy, receiving information corresponding to a call, determining domains that apply to the call, and applying policies associated with the determined domains.

Yet another embodiment comprises a computer program product, disposed on a computer readable medium, for providing call services at an application server. The computer program includes instructions for causing a processor to define a set of domains, some of which have a domain policy, to receive information corresponding to a call, to determine which domains apply to the call, and to apply policies associated with the determined domains.

Further, other advantages will become apparent in view of the following detailed description, including the figures, and the claims.

### BRIEF DESCRIPTION OF THE DRAWINGS

FIG. 1 is a diagram of a prior art system for providing call services;

FIG. 2 is a diagram of a prior art call model;

FIGS. 3-5 are diagrams illustrating operation of an application server featuring subscriber domains;

FIG. 6 is a flow-chart of a process for applying a domain policy to a call;

FIGS. 7-8 are diagrams illustrating operation of an application server featuring subscriber and service domains;

FIG. 9 is a diagram illustrating domain mapping of a call to a remote application server;

FIG. 10 is a diagram of a call model; and

FIG. 11 is a diagram of a computer platform suitable for executing application server instructions.

### DETAILED DESCRIPTION OF THE PREFERRED EMBODIMENTS

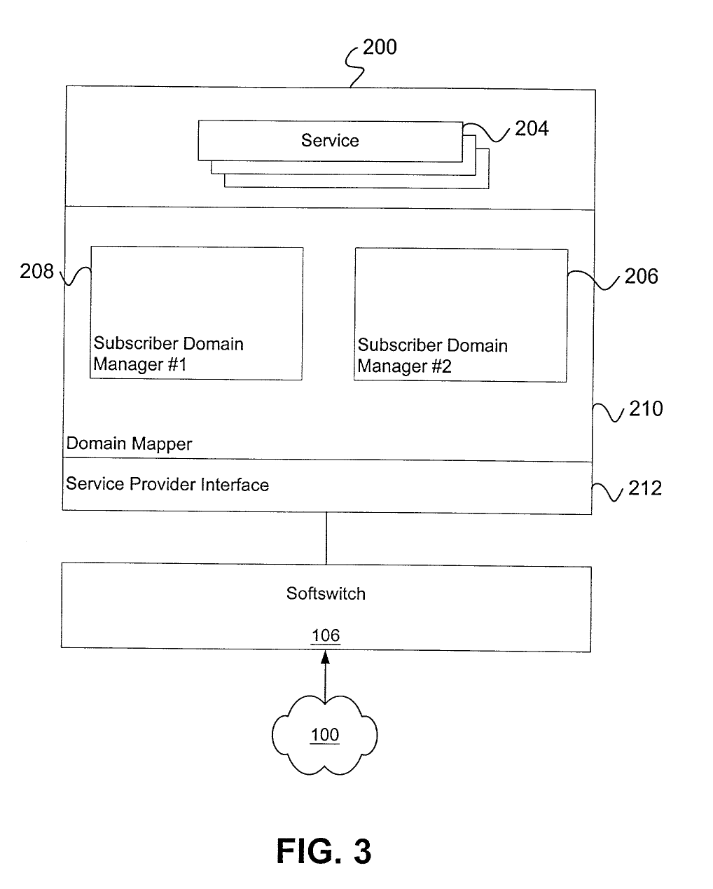

FIG. 3 illustrates an example of an application server 200 segmented into different domains. In the example of FIG. 3, each domain represents an aggregation of subscribers. For example, one domain may correspond to Verizon™ subscribers while another domain corresponds to Sprint™ subscribers.

Associated with each domain is a domain manager 206, 208. Domain managers 206, 208 can apply domain policies to calls mapped to their domain by a domain mapper 210. These policies can restrict subscriber access to different services. For example, a domain manager 206, 208 may implement a policy that denies access to a service 204 for subscribers that are behind in their payments.

Dividing an application server 200 into several domains enables a single application server 200 to support services 204 for a number of different business entities without robbing these entities of the ability to control server 200 access. That is, server 200 can offer services to both Verizon™ and Sprint™ subscribers. This can decrease the costs associated with providing calling services as different business entities no longer need to purchase and maintain an entire application server 200 for their own exclusive use.

In greater detail, application server 200 of FIG. 3 receives call information from softswitch 106 that processes network 110 packets corresponding to a call. While shown as communicating with softswitch 106, application server 200 may communicate with other call transport devices such as a web-server (not shown).

In the sample application server 200 architecture shown in FIG. 3, application server 200 includes service provider interface 212 that interacts with softswitch 106. Service provider interface 212 can be configured for different APIs (application programmer interfaces) offered by different call transport devices. For example, a first brand of softswitch 106 may present an event when a call arrives while another brand may merely maintain a queue of received calls for retrieval by application server 200. Service provider interface 212 can “normalize” the communication techniques offered by these softswitches 106 and create a uniform presentation of a call regardless of the underlying device. This generic wrapping of a given softswitch 106 or other transport device enables application server 200 to interact with a wide variety of transport devices 106 without requiring alteration of domain manager 206, 208 or service 204 programs such as voice-mail, call forwarding, and so forth.

As shown in FIG. 3, application server 200 includes a domain mapper 210 that can select one or more applicable domains based on call information. For example, based on a destination and/or origination phone number received from service provider interface 212, domain mapper 210 can identify the call as involving a subscriber belonging to one of the domains. For instance, domain mapper 210 may use a look-up table that associates addresses (e.g., phone numbers, e-mail addresses, and so forth) with particular subscribers or domains.

The domain manager 206, 208 associated with the subscriber's domain can apply its domain policy to the call, for example, to act as a “gatekeeper” by authorizing or denying access to a call service 204 provided by server 200. A domain manager 206, 208 policy may specify conditional logic (e.g., “IF” statements) expressed in Java or some other programming language and may access a wide variety of information to apply its policy. For example, a policy may have access to a subscriber's profile that stores a wide variety of subscriber demographic and business related information.

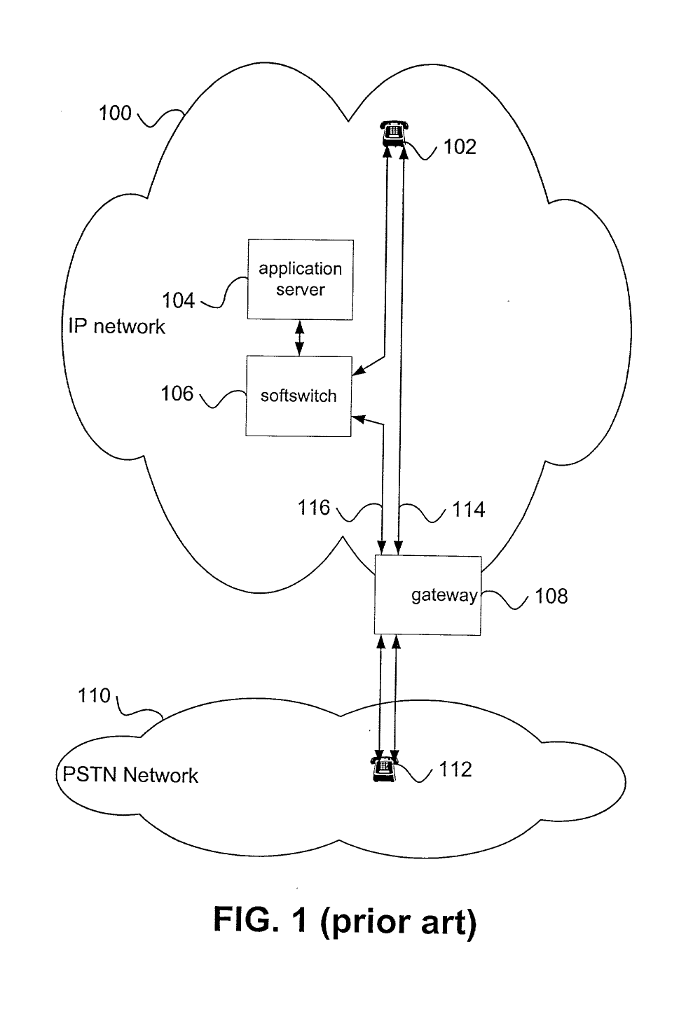

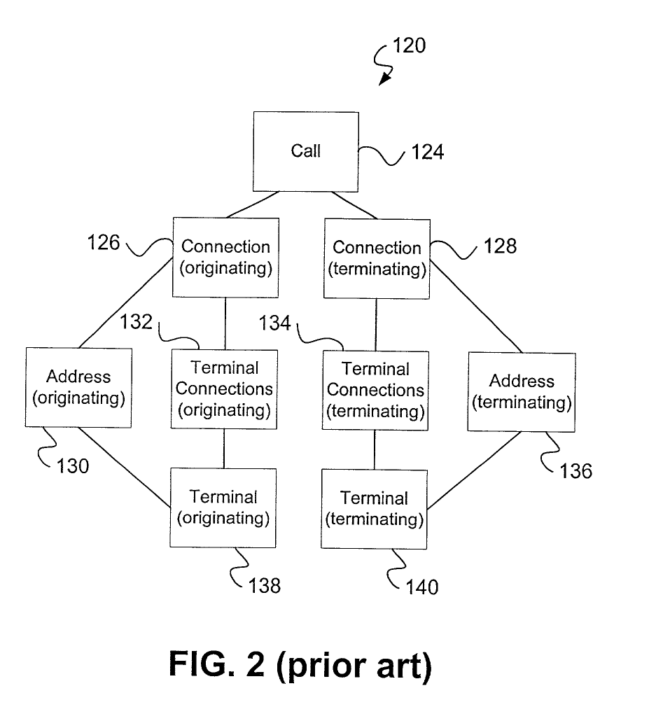

Though FIG. 1 illustrates an application server 200 as a single logical construct, application server 200 may actually be formed by a cluster of different computers programmed to provide the features described above. For example, often a separate back-end server, such as a media server, provides features associated with a particular service. Different clustered computers can communicate, for instance, using CORBA (Common Object Request Broker), RMI (Remote Method Invocation), and so forth.

Application server 200 need not include all the depicted components to support domains. For example, though providing deployment flexibility, server 200 need not include service provider interface 212 as described above.

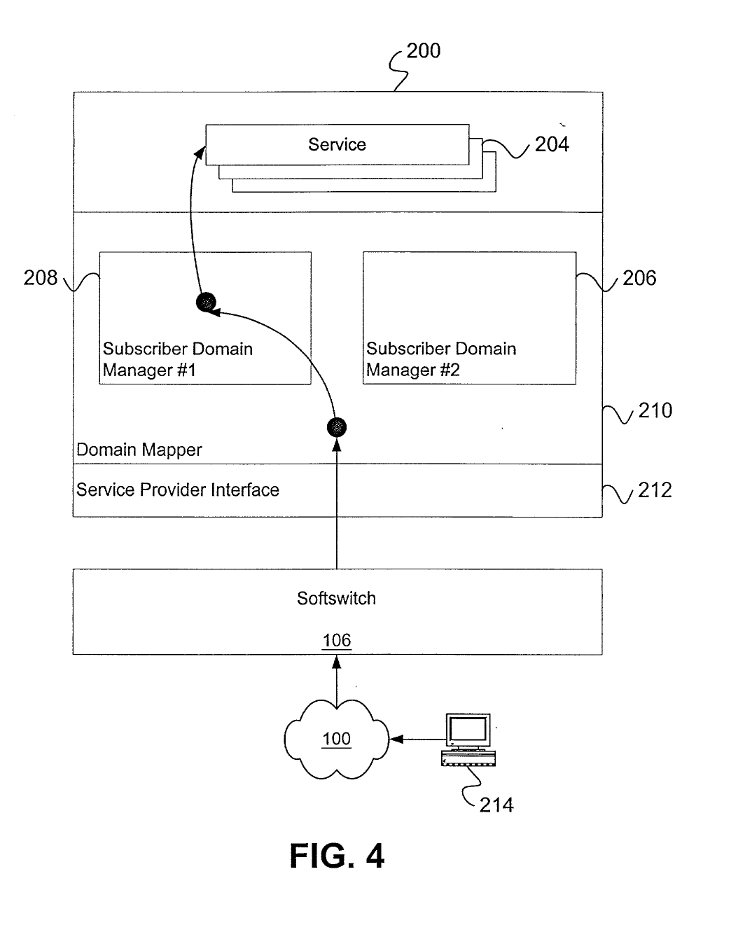

FIG. 4 illustrates sample operation of application server 200. In the scenario of FIG. 4, application server 200 provides a subscriber with access to a service 204, here voice-mail. As shown, a subscriber uses a computer 214 to “dial” a phone number of a voice-mail messaging service provided by application server 200. Network 100 routes the call packets from computer 214 to softswitch 106 associated with this phone number. Service provider interface 212 presents information about the call to domain mapper 210 for identification of the domain(s) associated with the call. For example, interface 212 may present information that includes the originating phone number of the subscriber. In this example, by identifying the originating phone call as the phone number of a subscriber of subscriber domain #1, the domain manager 208 of domain #1 can apply the domain policy for subscriber domain #1 to the call. As shown, domain manager 208 authorized access to voice-messaging service 204 sought by the caller.

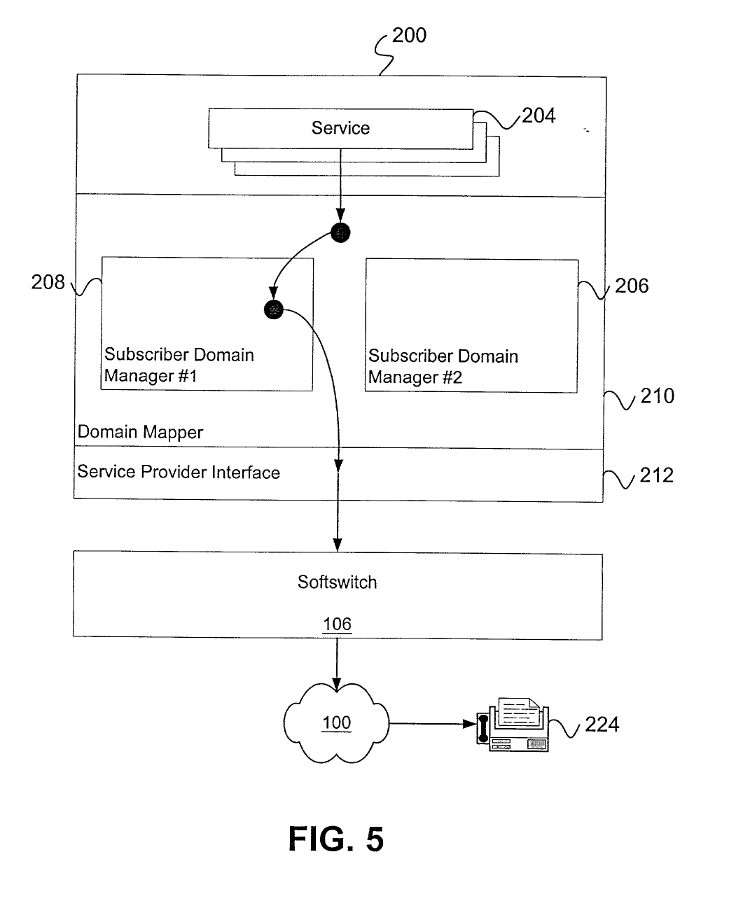

As shown in FIG. 5, domain manager 208 can apply its policy to any event or condition involving a domain, not just in-coming calls. For example, FIG. 5 illustrates a service 204, here a notification service, that automatically faxes a reminder letter to a subscriber's fax machine 224 at a specified time. As shown, rather than receiving call information from softswitch 106, domain manager 208 receives call information from service 204. Again, based on call information, such as the destination fax telephone number, domain mapper 210 can select a particular domain involved by the call. In turn, domain manager 208 of selected subscriber domain #1 can apply its domain policy to the call to determine whether service 204 can proceed. As shown, after authorization, service 204 can initiate and control a call to subscriber's fax machine 224.

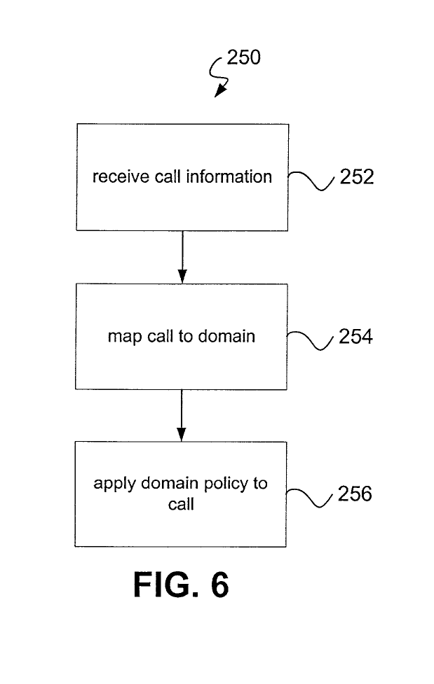

FIG. 6 presents a flow-chart of process 250 for handling a call at an application server featuring domains. After receiving call information (step 252), process 250 maps the call to one or more relevant domains (step 254). The mapped domain(s) then apply their domain policies, for example, to determine whether a call service can proceed (step 256).

Process 250 can apply to a wide variety of different types of domains. For example, while FIGS. 3-5 depicted subscriber domains, application server 200 may use domains that aggregate collections other than subscribers. For example, a domain may aggregate different services. Additionally, an application server may be segmented into different kinds of domains.

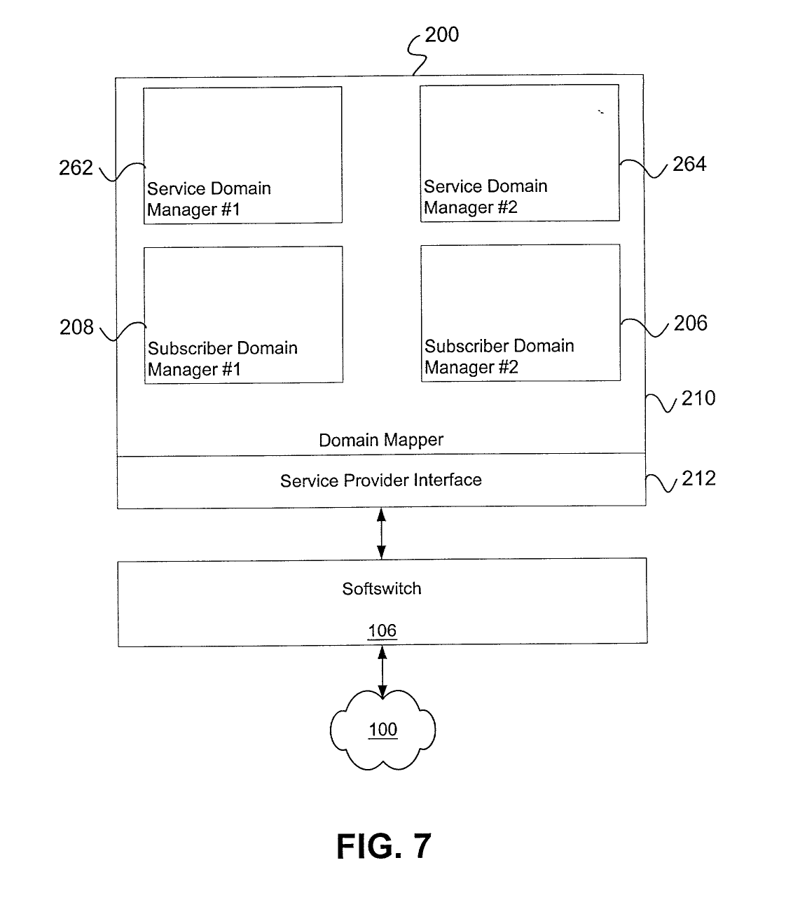

For example, as shown in FIG. 7, application server 200 includes subscriber domains and service domains. Again, the domains have associated domain managers 206, 208, 262, 264. As a call may involve both subscriber domains and service domains, multiple domain policies may affect a call.

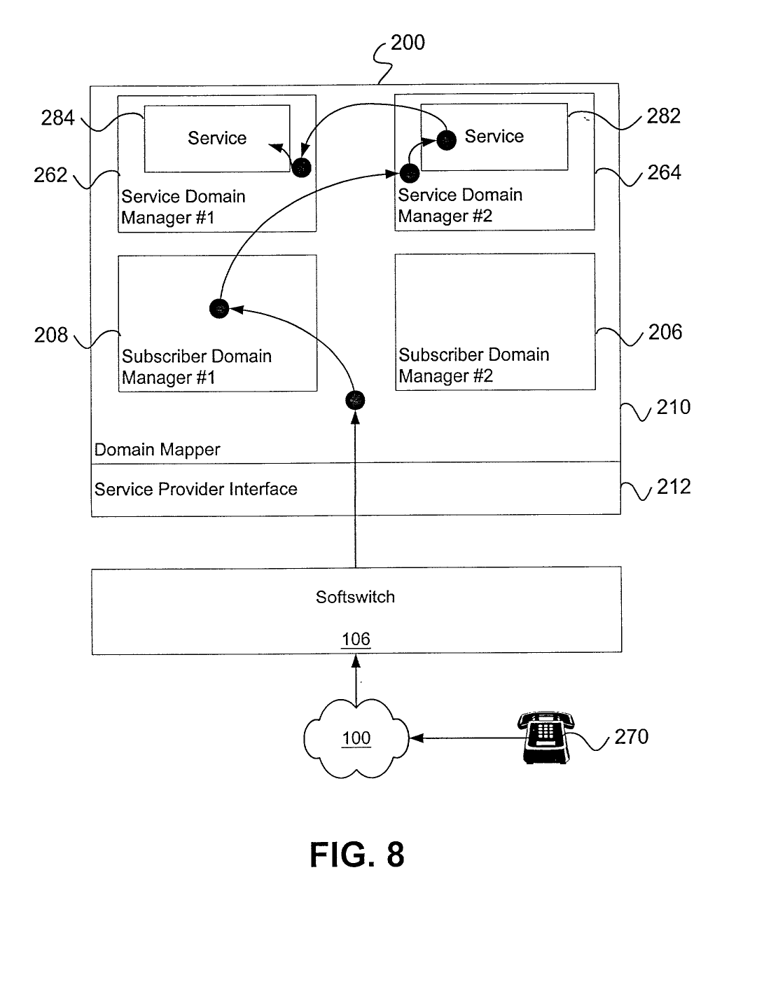

FIG. 8 illustrates operation of application server 200. Domain mapper 210 that initially maps a call from IP telephone 270 to subscriber domain 208. As shown, application of the subscriber domain's 208 policy results in a determination that the subscriber's call should be granted access to a particular service 282. This service 282 may reside within service domain #2. Thus, the corresponding service domain manager 264 applies its policy to the call. This policy may include, for example, logic that grants access to subscribers of a particular domain (e.g., Verizon™ subscribers) but not subscribers of another domain (e.g., Sprint™ subscribers). Assuming application of the service policy permits access, service 282 handles the call.

One service 282 may use a feature provided by another service 284 in another domain. As shown in FIG. 8, such a service domain manager 262 may apply its own domain policy to the other service's 282 request. Thus, the sample call scenario shown in FIG. 8 included application of no less than three different domain manager 208, 262, 264 policies.

Again, the domain managers 208, 262, 264 can enforce service level agreements (SLAs) between service providers. This can, for example, enable service providers to guarantee capabilities to subscribers. For example, in FIG. 8, a first service 284 may offer a unified messaging service that stores voice messages as “.wav” files for subsequent e-mailing. The first service 284 receives the “.wav” files from a media server service 282 that, for example, plays a greeting and records a message.

The first service domain may have an SLA with a second service domain based on the quality of service (QOS) required to record clearly understandable voice messages. For example, the SLA may specify a maximum value for dropped packets in a given time interval. Thus, the policy of the service domain including the unified messaging service 284 may include logic that rejects received “.wav” files when the QOS falls below the specified level. For example, the domain policy may include logic that consults an independent QOS monitor. Rather than, or in addition to, rejecting/denying access, a domain policy may record access attempts, for example, for billing or intra-domain notification of events.

The preceding described subscriber and service domains; however, other domains can represent different aggregations. For example, a device domain may represent different physical devices that may be involved in a call. Domain managers of these physical device domains may feature policies that may limit services available to particular devices. For instance, a device domain policy may prevent video conferencing on devices that typically lack resolution to present a clear image.

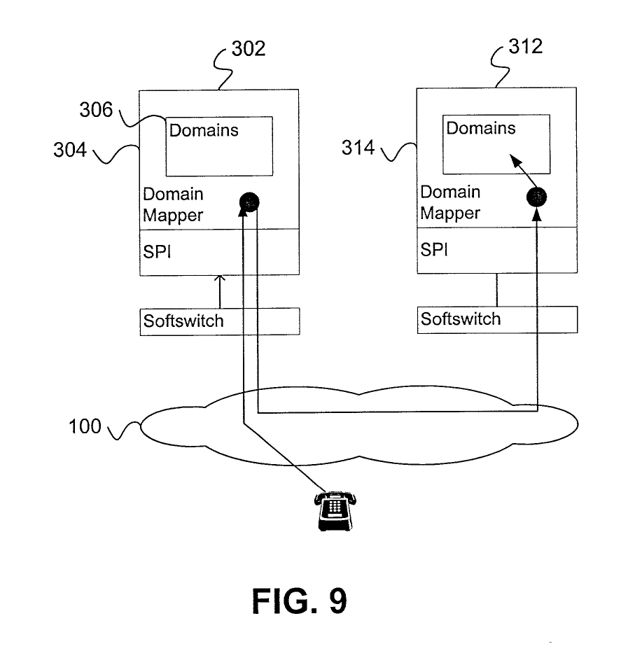

As shown in FIG. 9, a first application server 302 may handle a call that does not map to any of its domains 306. In such a case, first server 302 may attempt to transfer call handling to a second application server 312 that provides an applicable domain. For example, each server 302, 312, respectively, may be assigned a given geographic zone to cover such as the geographic region(s) covered by a set of area codes. When domain mapper 304 of first server 302 receives information for a call and fails to identify an applicable domain, first server 302 may attempt to transfer call handling to second server 312 responsible for the area code represented by a destination or origination phone number of the call.

For example, in FIG. 9, after domain mapper 304 determines that no domains correspond to a call, first server 302 can transfer call handling to the second server 312 covering the area code of the destination and/or origination phone numbers. Once transfer occurs, the domain mapper 314 of the transferred call handles the call as described above.

A wide variety of other mechanisms can intelligently distribute call handling across different application servers. For example, a network server (not shown) may receive call information from first application server 302 not having an applicable domain and, potentially, select a second server 312 for call handling.

The features described in conjunction with FIGS. 3-9 may be implemented in a wide variety of ways. For example, as a part of handling a call, application server 200 may construct a call model. By consistently modeling a call with a given set of objects, an application programmer can quickly write service code independent of the underlying transport device's call presentation.

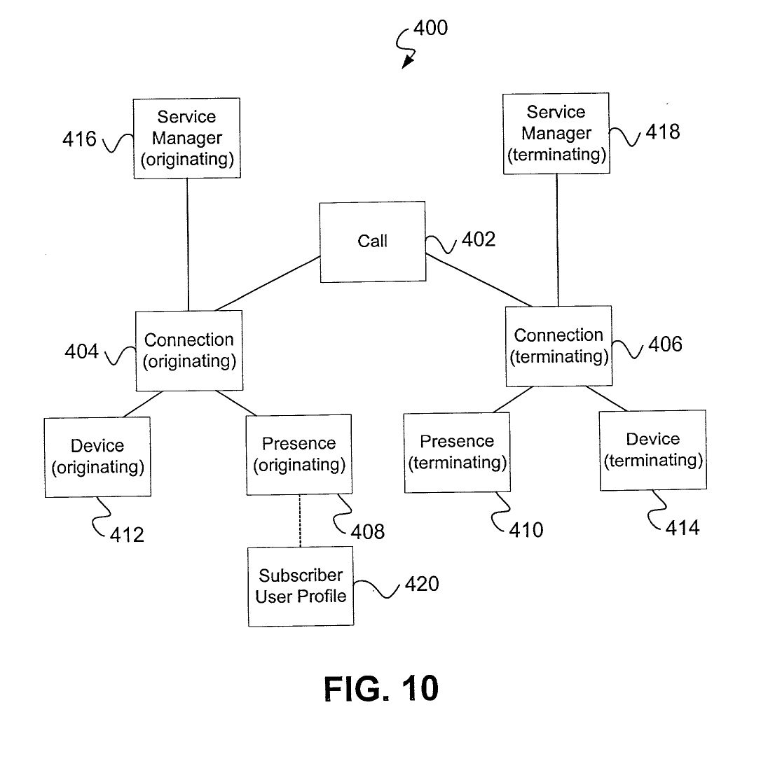

Instead of JTAPI, server 200 may use a call model akin to the object call model 400 shown in FIG. 10. The objects 402-418 in the call model 400 may be implemented, for example, using Enterprise Java Beans (EJB). In terms of the application server architecture described above, the domain manager may instantiate call model objects 402-418 after mapping of a call to the manager's domain. As a call may map to multiple domains (e.g., when both the destination address and origination address correspond to different subscriber domains), call model objects 400 may be distributed across different domains. For example, the “origination” side of call model 400 (e.g., objects 404, 408, 412, and 416) may reside within one domain, while the “termination” side of call model 400 (e.g., objects 406, 410, 414, and 418) may reside in another domain.

In greater detail, call model 400 shown in FIG. 10 includes call 402 and connection 404, 406 objects that, respectively, represent call data and the logical connections between different physical devices (represented by objects 412, 414).

Call model 400 also includes presence objects 408, 410. Presence objects 408, 410 represent some system user or service involved in the call. Presence objects 408, 410 can incorporate both persistent and transient data. For instance, subscriber presence 408 may feature transient data such as call duration and persistent data such as data retrieved from a subscriber's user profile 420, for example, stored in a LDAP (Lightweight Direction Access Protocol) server. User profile 420 can store user preferences, service selections, demographic information, billing data, and so forth. Again, presence 408, 410 may also represent a service, such as a media server, involved in a call.

In call model 400, an entity is represented by presence 408 regardless of whether the entity actually participates in a call. For example, if a called party is not available, a “proxy” presence is instantiated to represent the party.

Call model 400 can feature individual presences 408 or group presences (not shown) that represent a group of users. A group presence may, for example, permit call forwarding to a group with the presence including logic/data for selecting a specific group member for participation in the call. The call model 400 may also feature a “role” object (not shown) that can represent the capacity of a user (e.g., secretary or technical support person).

Call model 400 also includes service manager objects 416, 418 that invoke services. Since a given call may have multiple services that may apply, service manager objects 416, 418 can be configured to coordinate call handling to avoid or resolve feature interactions between the different services. For example, a system user may subscribe to two different modes of call forwarding such as forwarding to a voice-mail service and forwarding to some specified phone number. Service manager 416, 418 can invoke one, for example, to the exclusion of the other, for example, based on user preferences.

In operation, upon receipt of a call, a domain manager instantiates presence 408 which, in turn, activates service manager 416. Service manager 416 decides what service or service features to invoke in response to a particular event or condition.

While call model 400 described above offers a number of potential advantages, such as avoidance of feature interaction, the domain architecture does not depend on this or another specific call model.

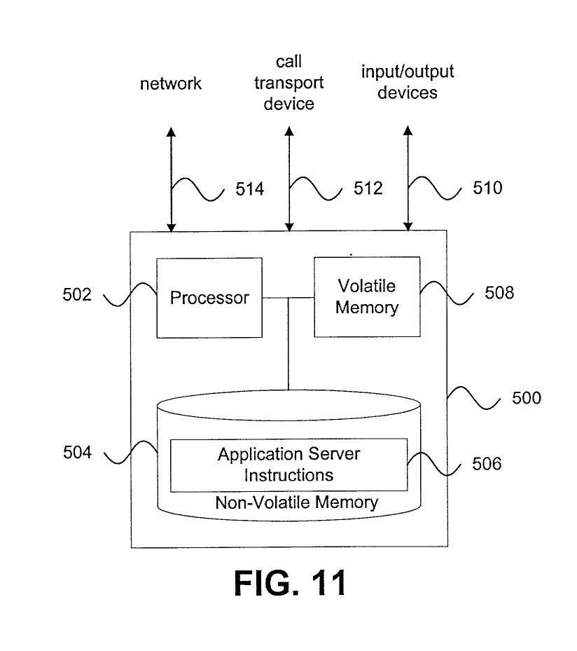

FIG. 11 illustrates a computer platform 500 suitable for providing application server features described above. Platform 500 includes one or more processors 502, volatile memory 508 and/or non-volatile memory 504. As shown, the non-volatile memory 504 (e.g., a hard disk, CD-ROM, and so forth) stores application server instructions 506. In the course of typical operation, instructions 506 are transferred to volatile memory 508 and processor 502 for execution. As shown, platform 500 can communicate with a call transport device (e.g., softswitch or web-server) over a call transport connection 512. Platform 500 may also feature an I/O (Input/Output) connection 510 with one or more input/output devices such as a keyboard, monitor, mouse, and so forth. Platform 500 may also feature network connection 514, for example, for receiving SNMP (Simple Network Management Protocol) application server configuration messages.

The techniques described herein are not limited to any particular hardware or software configuration. The techniques may be implemented in hardware or software, or a combination thereof. Preferably, the techniques are implemented in computer programs. Each program is preferably implemented in high level procedural or object oriented programming language. However, the programs can be implemented in assembly or machine language, if desired. Furthermore, the language may be compiled or interpreted language.

Each such computer program is preferably stored on a storage medium or device (e.g., CD-ROM, hard disk, or magnetic disk) that is readable by a general or special purpose programmable computer for configuring and operating the computer when the storage medium or device is read by the computer to perform the procedures described herein. The system may also be considered to be implemented as a computer-readable storage medium, configured with a computer program, where the storage medium so configured causes a computer to operate in a specific and predefined manner.

Other embodiments are within the scope of the following claims.

What is claimed is:

1. A method of handling a call at an application server offering one or more services, the method comprising:
receiving information corresponding to said call at the application server, the information including data identifying a subscriber of said one or more of services offered by the application server;
based on the information corresponding to the call, selecting a domain policy, the domain policy applying to a set of subscribers; and
handling the call in accordance with the selected domain policy.

2. The method of claim 1, wherein receiving information corresponding to a call comprises receiving information from a softswitch.

3. The method of claim 1, wherein the information including data identifying a subscriber comprises at least one of the following: an origination phone number and a termination phone number.

4. The method of claim 1, wherein the domain policy comprises a policy encoded in a programming language including conditional expressions.

5. The method of claim 1, further comprising constructing a call model for the call.

6. The method of claim 1, further comprising:
determining a service domain having a call service; and
applying the domain policy of the determined service domain to the call.

7. The method of claim 1, wherein handling the call in accordance with the selected domain policy comprises authorizing the call.

8. A method of providing call services at an application server, the method comprising: defining a set of at least two domains, at least some of the domains having a domain policy;
receiving information corresponding to a call;
determining one or more domains that apply to the call; and
applying policies associated with the determined domains to the call.

9. The method of claim 8, wherein the domains comprise more than one subscriber domain.

10. The method of claim 8, wherein the domains comprise more than one service domain.

11. The method of claim 8, wherein the domains comprise more than one device domain.

12. The method of claim 8, wherein the domains comprise more than one subscriber domain and more than one service domain.

13. The method of claim 8, wherein the policies comprise policies encoded in a computer programming language including conditional expressions.

14. An application server, comprising:
one or more aggregation domains, at least some of the domains having an associated authorization policy; and
a domain mapper that identifies one or more domains based on call information.

15. The application server of claim 14, wherein the domains comprise subscriber domains.

16. The application server of claim 15, wherein the domains comprise service domains.

17. The application server of claim 15, further comprising a service provider interface for handling call information received from a transport device.

18. The application server of claim 17, wherein the transport device comprises a softswitch.

19. A computer program product, disposed on a computer readable medium, for providing call services at an application server, the computer program including instructions for causing a processor to:
define a set of more than one domains, at least some of the domains having a domain policy;
receive information corresponding to a call;
determine one or more domains that apply to the call; and
apply policies associated with the determined domains to the call.

20. The computer program of claim 19, wherein the domains comprise more than one subscriber domain.

21. The computer program of claim 19, wherein the domains comprise more than one service domains.

22. The computer program of claim 19, wherein the domains comprise more than one subscriber domain and more than one service domain.

23. The method of claim 19, wherein the policies comprise policies encoded in a computer programming language including conditional expressions.
